(19) United States
(12) Patent Application Publication
(10) Pub. No.: US 2014/0074404 A1
(43) Pub. Date: Mar. 13, 2014

(54) Theme Park Combined Queue/Guest Management, Park Loading & Navigation System

(71) Applicant: Gokhan Hassan, Kent (GB)

(72) Inventor: Gokhan Hassan, Kent (GB)

(73) Assignee: Gokhan Hassan, Kent (GB)

(21) Appl. No.: 13/609,323

(22) Filed: Sep. 11, 2012

(30) Foreign Application Priority Data
Sep. 11, 2012 (GB) 1216133.7

(51) Int. Cl. G01C 21/00

(52) U.S. Cl. 701/540; 701/400

(57) ABSTRACT

Queue management, park loading and navigation system, which calculates and manages routes for guests to reduce or eliminate queuing times.

### BACKGROUND

This invention relates to an intelligent Theme Park combined queue/guest management, park loading and navigation system.

Theme Parks have become considerably busier in the past 20 years and are popular with families, singletons and couples alike. The parks can't open new rides fast enough to accommodate the demand and therefore the queues for the rides are becoming longer by the year. The most popular of rides can have queues for up to 3 hours and with most parks only open for 8 hours on any one given day, guests aren't justifying spending a large amount of cash for using a handful of rides.

This results in dissatisfied guests who would be unlikely to re-visit a park if they were unhappy with the queue times. Some prospective guests are also put off by the potential queues as the industry is now renowned for it.

Guests can also struggle to navigate their way round a large park in an efficient manner.

Methods and systems have been derived in the past, such as fast-track tickets and ride reservations. These only benefit a small minority of guests who are willing to pay further money on top of the already expensive entrance fee. Other guests who don't take advantage of these systems tend to become frustrated and infuriated at other guests seemingly ‘jumping’ the queue.

Another system is described in US 2009/0313062, which offers incentives to guests to use rides with less queues. It doesn't give an option to the guest to select their desired rides for the day and is more suited to a queue tracker system, of which there are many that exist. It encourages guests to move ahead of the existing line based on pre-determined factors, whilst it is also severely over-complicated and incentivised.

This invention doesn't require guests to check-in and out of each location. It encourages the guest to select the rides they wish to use on the day to ensure they get what they want out of their ticket and aren't left feeling as though they haven't achieved what they set out to do. They can tick their device if they are satisfied with their turn on the ride. This invention is designed so that other guests are not caused any upset or anger by people jumping the queues or having purchased expensive ‘fast-track’ tickets. The invention is intended to provide an equal and fair basis for all guests and ultimately, to ensure they make the most out of their ticket. This is a simple system that guests don't need to over-think on how to make the most of it.

Accordingly, to date, there is no suitable system or method in place to manage theme park guests, load out a theme park efficiently, navigate them around the park and reduce queue times without the need for incentives.

### STATEMENT OF INVENTION

To overcome this, the present invention of an intelligent Theme Park Queue/Guest Management, Park Loading & Navigation System will allow the park owners to automatically organise what visitors will go on what rides at certain times to reduce or completely eliminate queuing times as per the guest's requests.

It is a method for the guest to enter their desires for the day and for the park to ensure that they achieve this without isolating the guests who do not wish to pay extra for fast-track or pre-reserved rides.

It also combines as a navigation system around the park. This is all achieved through a system comprising of a main computer processor, handheld identification and navigation devices, and queue detectors.

### ADVANTAGES

Customers will no longer find themselves lost in the park as the system will navigate them to each ride at a designated time depending on their progress through the park.

Customers can plan what rides they want to use on the day of their visit and the system will mean that they won't be disappointed on missing out on any rides because of excessive queues.

Theme Park owners would be able to attract new guests who were previously put off by the infamous reputation of lengthy queues at theme parks, and repeat business from existing guests would increase who would be extremely satisfied at the level of organisation at the park and the amount of rides they managed to enjoy.

### DRAWINGS

An example of the invention will now be described by referring to the accompanying drawings:

FIG. 1 shows the interaction between the guest and the system computer; and

FIG. 2 shows the basic details of the Theme Park Queue Management, Park Loading & Navigation System.

In FIG. 1 it details the interaction between the guest and the local park computer and its recordings. The computer calculates the amount of guests using that ride in a day. It then navigates routes for each guest to take a different route therefore eliminating congestion at busy rides. I.e. a certain percentage go round the park clockwise, another group go anti-clockwise, etc. This assists with loading the park accordingly.

FIG. 2 shows a basic overview of a park and the components of the Theme Park Queue Management, Park Loading & Navigation System. Initially the guest selects the rides that hw/she is interested in, which feeds back to the computer system. The computer system works out how many people would like to use that ride on that day and staggers them on different routes, so that they don't all reach the same ride at the same time. It is constantly receiving updates from the handheld devices and the queue detectors, which enables the computer system to calculate automatically the best routes and adjust any routes accordingly. The handheld device also acts as a navigator, thus ensuring clear directions are instructed to the guest, so that they don't have to spend considerable amounts of time planning their route through the park and potentially finding themselves inadvertently lost.

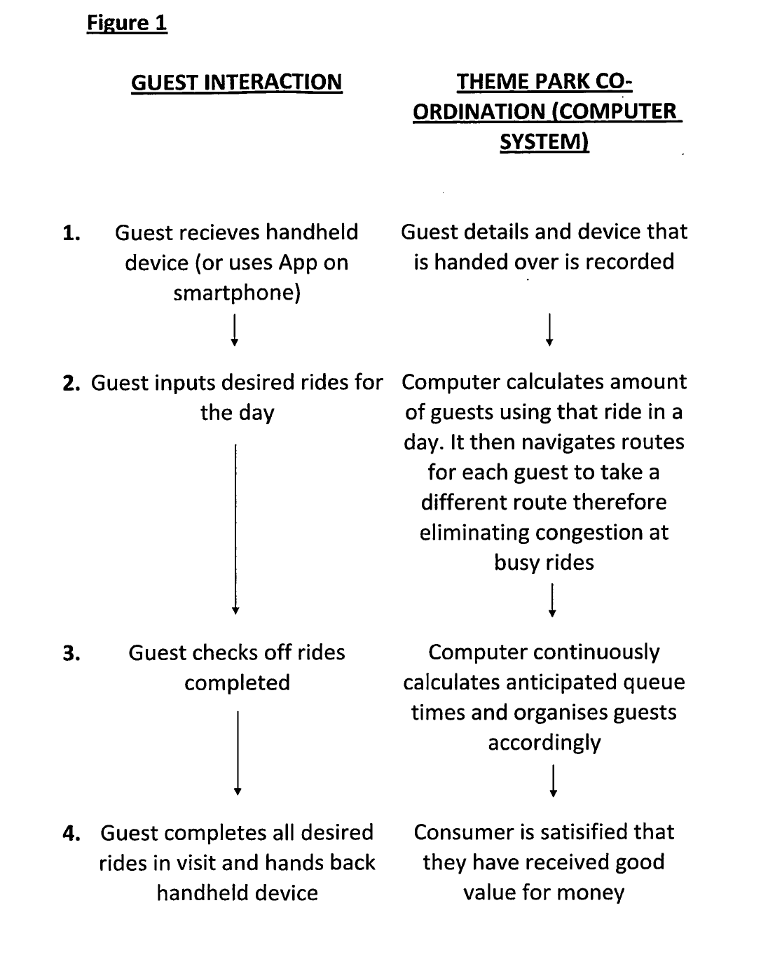

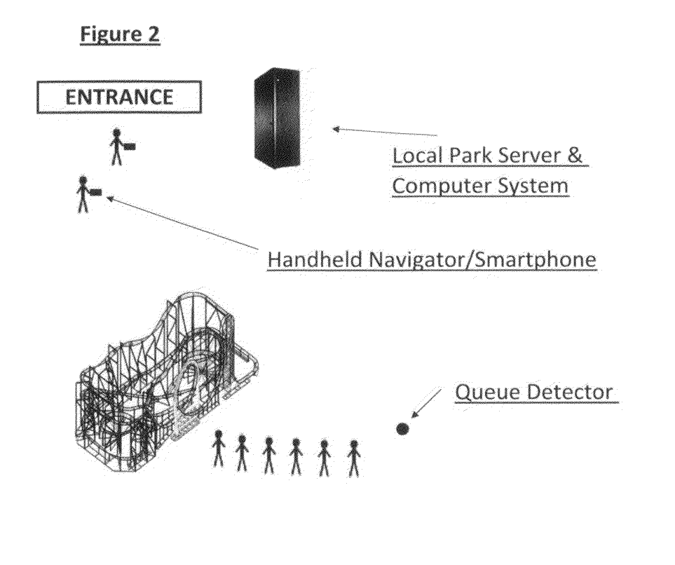

### DETAILED DESCRIPTION

The system will manage the guests and combine this with providing navigation to the pre-determined rides that they have selected. This is achieved through a handheld device handed to the guest at the entrance of the park, of which the information is relayed to a central computer and this data is combined with the information emitted from the queue detectors located throughout the park.

Specific configurations and arrangements of the claimed invention, discussed below with reference to the accompanying drawings, are for illustrative purposes only.

As used herein, an element or function recited in the singular and proceeded with the work “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

In one embodiment of the present invention, the handheld devices are given to each guest as they enter the park. The devices are recorded by the management of the park by way of a bar-code, IP address, serial number, or the like. This device can be tracked by the processor to maintain the known presence of the guest and what rides they have completed and are yet to complete. This can be rented by the guest, or lent by the park, depending on the management's choice. The guest enters on the handheld device the rides they wish to visit throughout the day and enter the number of guests within their group sharing the device. They can also select any ride for information on the specific details, such as; height restrictions, live queuing times, when they are anticipated to enter this ride and local amenities.

The computer (main processor) automatically and constantly calculates the amount of visitors seeking to enjoy a ride by way of using the information that they enter on to their park-issued handheld device. It uses this information to work out how long the queues will be and therefore staggers the guests to different areas of the park to avoid ride congestion and thus reducing the queues—this is an innovative new loading method. This can be carried out via a hard-wired system to the queue detectors, wireless communication, or any other suitable technologies. The main processor will contain the required software to achieve these functions and specifications, as follows, but not limited to; hard disc storage, data storage, data retrieval and processing chips.

The queue detectors located at each ride would be placed at strategic points to enable it to estimate the number of guests in the queue by relaying this against the position of the detectors against the entrance to the ride. This would calculate the current queue time, which would be provided to the main processor for incorporation in to its calculations.

Guests would also be able to select what time they would like lunch or refreshments and the handheld device would present them with options that are local, or within a reasonable distance. Adjustments can be made at any point by the guest as to what rides they wish to embark on or skip. The system becomes more effective if the majority, or all of the guests are using this system.

1. Queue/guest management, park loading and navigation system, which calculates routes for guests to reduce or eliminate queuing times and to navigate guests around the park.

2. Comprising according to claim 1, of a computer system acting as the main processor, which automatically retrieves data from the handheld devices and detectors to manage and co-ordinate the guests in the park.

3. Comprising according to claim 1, of queue detectors located at every ride and eateries throughout the park.

4. Comprising according to claim 1, of handheld devices issued to guests at the park entrance, whereby they can plan their day at the park in conjunction with the main processor.
